(19) United States
(12) Patent Application Publication
(10) Pub. No.: US 2025/0033487 A1
(43) Pub. Date: Jan. 30, 2025

(54) DRIVE SYSTEM FOR AN AT LEAST PARTIALLY ELECTRICALLY DRIVEN MOTOR VEHICLE AND METHOD

(71) Applicant: Dr. Ing. h.c. F. Porsche Aktiengesellschaft, Stuttgart (DE)

(72) Inventors: Thomas HUBERT, Leonberg (DE); Max Valentin MUELLER, Munich (DE)

(21) Appl. No.: 18/772,306

(22) Filed: Jul. 15, 2024

(30) Foreign Application Priority Data
Jul. 25, 2023 (DE) 10 2023 119 589.1

(51) Int. Cl. B60L 15/20; B60L 15/00

(52) U.S. Cl. CPC B60L 15/20; B60L 15/007

(57) ABSTRACT

A drive system, including an electric traction drive with electric traction motors, wherein at least one of the traction motors is a permanently excited synchronous machine having a rotor with a plurality of permanent magnets and a stator with a magnetic field generator for generating a stator magnetic field. The drive system further includes at least one controller configured to switch off the at least one traction motor as a function of a load state of the drive system at least in partial load operation, such that the at least one traction motor is in a towing mode and is towed along while another of the at least two traction motors is still switched on and supplies a torque for driving. The controller generates a defined magnetic field with the magnetic field generator and demagnetizes the permanent magnets with a demagnetization field such that drag losses are reduced when towing.

### CROSS REFERENCE TO RELATED APPLICATIONS

This application claims benefit to German Patent Application No. DE 10 2023 119 589.1, filed on Jul. 25, 2023, which is hereby incorporated by reference herein.

### FIELD

The present invention relates to a drive system for an at least partially electrically driven motor vehicle with an electric traction drive with at least two electric traction motors.

### BACKGROUND

Such drive systems are particularly suitable for electric vehicles, as one of the traction motors can be switched off and be towed for efficiency reasons, for example in partial load operation. In the automotive industry, permanently excited synchronous machines (PSM) are often used as traction motors due to their high torque density and efficiency. The excitation of the rotor is realized by permanent magnets. Rare-earth magnetic materials such as NeFeB are used for this purpose.

However, PSMs have the disadvantage that they have comparatively high drag losses when towing (eddy current and hysteresis losses). Here, separately excited synchronous machines (FSM) or asynchronous machines (ASM) offer a clear advantage over PSM, as the excitation field can simply be switched off when towing or there is no active excitation in the rotor.

### SUMMARY

In an embodiment, the present disclosure provides a drive system for an at least partially electrically driven motor vehicle, comprising an electric traction drive with at least two electric traction motors, wherein at least one of the traction motors is a permanently excited synchronous machine having a rotor with a plurality of permanent magnets and a stator with a magnetic field generator for generating a stator magnetic field. The drive system further comprises at least one controller configured to switch off the at least one traction motor as a function of a load state of the drive system at least in partial load operation, such that the at least one traction motor is in a towing mode and is towed along while another of the at least two traction motors is still switched on and supplies a torque for driving. The controller is configured to generate a defined magnetic field with the magnetic field generator and to at least partially demagnetize the permanent magnets of the at least one switched-off traction motor with a demagnetization field of the defined magnetic field such that drag losses are reduced when towing.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a highly schematized representation of a drive system according to the invention.

### DETAILED DESCRIPTION

Embodiments of the present invention provide an improved drive system for an at least partially electrically powered motor vehicle. In particular, a high torque density and efficiency and at the same time the lowest possible drag losses are provided.

Further advantages and features of embodiments of the present invention will emerge from the general description and the description of the example embodiment.

The drive system according to an embodiment of the invention is provided for an at least partially electrically driven motor vehicle and preferably for an electric vehicle. However, it can also be used in a hybrid vehicle. The drive system comprises at least one electric traction drive with at least two electric traction motors. At least one of the traction motors is designed as a permanently excited synchronous machine. The traction motor or synchronous machine has a rotor with a plurality of permanent magnets (for generating a rotor magnetic field or excitation field). The traction motor or synchronous machine has a stator with a magnetic field generating device for generating a stator magnetic field or rotating field. In particular, the rotor is rotatable relative to the stator. The drive system comprises at least one control device which is suitable and designed to switch off at least the traction motor, which is designed as a permanently excited synchronous machine, depending on a load state of the drive system and in particular at least during partial load operation. As a result, this traction motor is in towing mode and is towed along. In particular, the traction motor is in towing mode while the at least one other traction motor is still switched on and supplies torque for driving. The control device is suitable and designed to generate a defined magnetic field, the so-called demagnetization field, by means of the magnetic field generating device. The control device is suitable and designed to use the demagnetization field to at least partially demagnetize the permanent magnets of the at least one switched-off traction motor in order to reduce drag losses when towing.

The drive system according to embodiments of the invention offer many advantages. The targeted and on-demand demagnetization of the permanent magnets when towing offers a considerable advantage. This means that the advantages of a permanently excited synchronous machine can be achieved with particularly low drag losses. Another advantage is that the existing stator can be used for demagnetization. However, coils can also be used for demagnetization, which can be fitted in or on the rotor to save installation space.

Preferably, the control device is suitable and designed to generate a defined magnetic field, in particular the magnetization field, by means of the magnetic field generating device and thus to magnetize the previously demagnetized permanent magnets of the at least one switched-off traction motor again. In particular, this allows the traction motor to deliver the intended torque for driving and/or to be switched on again. In particular, the permanent magnets are magnetized again as they were before demagnetization.

The control device is particularly suitable and designed to magnetize the traction motor again at least when a torque request is present, for the provision of which the at least one switched-off traction motor is required or provided. In particular, an algorithm is stored in the control device which defines a relationship between the torque requirement and the required traction motors. In particular, the control device is suitable and designed to carry out magnetization depending on a load state of the drive system and, in particular, during full-load operation and/or overrun operation with energy recovery (for example, recuperation operation) and/or for brake assistance.

Preferably, the control device is suitable and designed to generate the defined magnetic field with a defined magnetic field direction by means of the magnetic field generating device. In particular, the control device is suitable and designed to set a magnetic field direction for the magnetization field that is opposite to the magnetic field direction of the demagnetization field. In particular, the control device can set the magnetic field direction of the defined magnetic field.

It is advantageous and preferred that at least one current pulse is used to generate the defined magnetic field (in particular the demagnetization field and/or magnetization field). In particular, the current pulse is adjustable. Preferably, the current pulse has a higher (maximum) current strength and/or higher (maximum) amplitude than the nominal current intended for the permanently excited synchronous machine and in particular for its stator (in nominal operation). The (maximum) current strength and/or the (maximum) amplitude of the current pulse is in particular at least 1.5 times and preferably at least twice and particularly preferably at least 2.5 times the nominal current. It is also possible and advantageous that the (maximum) current strength and/or the (maximum) amplitude of the current pulse is at least three times or at least four times or at least five times the nominal current.

In an advantageous embodiment, the current pulse provided to generate the defined magnetic field can be provided at least partially by power electronics of the traction drive and particularly preferably by an inverter device. The inverter device is used in particular to provide a traction current for the traction drive. In particular, the inverter device can be used to generate a traction current with an adjustable frequency and/or current strength and/or amplitude. In particular, the energy for the current pulse is taken from a traction battery.

The current pulse provided to generate the defined magnetic field can preferably be provided at least partially by a capacitor device. The capacitor device can provide at least part of the current pulse in addition to or as an alternative to the power electronics or the inverter device.

In particular, the control device is suitable and designed to adjust the current pulse at least in terms of amplitude and/or current strength and/or current direction and/or frequency. In particular, the control device can control the power electronics and/or the capacitor device accordingly. In particular, the current pulse is provided by the magnetic field generating device.

The control device is particularly suitable and designed to set a current direction of the current pulse provided to generate the defined magnetic field. In particular, the control device is suitable and designed to set a current direction for the magnetizing field that is opposite to the current direction of the demagnetizing field. In particular, the control device can set the current direction by means of a switching arrangement. In particular, the switching arrangement is operatively connected to the power electronics and/or the capacitor device or is part of one of these devices.

In an advantageous embodiment, it is provided that the control device is suitable and designed to apply the defined magnetic field (for demagnetization and/or magnetization) to the at least one traction motor at least under the condition that the at least one (other) traction motor is switched on and supplies a torque for driving and/or that the drive system is in motion. This means that the influence of the defined magnetic field on driving behavior can be kept particularly low.

Preferably, the control device is suitable and designed to adjust the torque of the at least one traction motor while the defined magnetic field is applied to the at least one traction motor so that unwanted torque pulses can be avoided. This enables particularly comfortable and safe driving operation, even while the traction motor is magnetizing. For example, the synchronous machine is prevented from providing a torque during demagnetization or magnetization that would lead to a noticeable jolt when the vehicle is being driven. In particular, the adjustment takes place, taking into account a torque which the traction motor feeds into the drive system due to the defined magnetic field. In particular, the torque of (all of) the traction motors of the drive system is constantly adjusted while the defined magnetic field is applied to the at least one traction motor.

In an advantageous embodiment, the drive system comprises at least two axle units. The least two axle units comprise in particular at least one front axle and at least one rear axle. In particular, the axle units can each be driven by at least one of the at least two traction motors. In particular, the control device is suitable and designed to switch off and demagnetize the at least one traction motor provided for driving at least one of the at least two axle units depending on the load state of the drive system, so that the towing mode can be provided axle by axle. In particular, at least one axle unit is towed while at least one axle unit is driven. In particular, at least one of the at least two axle units is not driven in towing mode. In particular, the axle units each comprise at least two wheels.

In an advantageous embodiment, the drive system comprises at least one front axle that can be driven by at least one traction motor and at least one rear axle that can be driven by at least one traction motor. In particular, the control device is suitable and designed to switch off and demagnetize the at least one traction motor provided for driving the front axle depending on the load state of the drive system, so that the front axle is also towed while the rear axle is driven. This offers particularly efficient driving and enables, for example, an extension of the range of an electric vehicle.

It is also possible and advantageous that the control device is suitable and designed to switch off and demagnetize the at least one traction motor provided for driving the rear axle depending on the load state of the drive system, so that the rear axle is also towed while the front axle is driven. It is also possible for the control device to demagnetize both the at least one traction motor of the front axle and the at least one traction motor of the rear axle so that, for example, rolling operation is possible with particularly low losses.

In particular, a magnetic coercive field strength of the permanent magnets of the at least one traction motor designed as a permanently excited synchronous machine and the defined magnetic field that can be generated by the magnetic field generating device are matched to one another. In particular, magnets are provided whose magnetic coercive field strength is specifically adapted and, for example, specifically reduced compared to conventional permanent magnets of a comparable permanently excited synchronous machine. This enables particularly reliable demagnetization and magnetization.

In particular, an algorithm is stored in the control device which defines a relationship between the coercive field strength of the permanent magnets and the magnetic field strength and/or magnetic field direction and/or the amplitude and/or direction of the current pulse required for demagnetization or magnetization. In particular, such correlations were previously determined numerically and/or experimentally. In particular, the permanently excited synchronous machine is designed in such a way that these relationships can be implemented.

The method according to an embodiment of the invention is used to operate a drive system in particular as described above. The method also solves the aforementioned problem in a particularly advantageous manner. In particular, the method is designed such that it can be used to operate the drive system according to embodiments of the invention and preferably also its embodiments. In particular, the method is designed in such a way that it can also be used to carry out operations that can be performed by the control device described here. In particular, the control device is suitable and designed to carry out the method and, in particular, its embodiments. In particular, the control device is suitable and designed to carry out the steps formulated in a method-like manner in the context of embodiments of the present invention. In particular, the control device comprises at least one algorithm for carrying out the steps described here.

It is possible that the at least two electric traction motors are each designed as permanently excited synchronous machines. In particular, the traction motors then each have a rotor with a plurality of permanent magnets and a stator with a magnetic field generating device. However, it is also possible that at least one of the at least two electric traction motors is designed as a different type of machine.

In the context of embodiments of the present invention, switching off the traction motor means in particular that the traction motor is no longer activated to provide an active torque. However, basic control including a power supply is still possible and preferred in the switched-off state. In the context of embodiments of the present invention, switching on the traction motor means in particular that the traction motor is activated to provide an active torque. In particular, the demagnetization and magnetization of the at least one traction motor is provided during driving operation or while driving.

In particular, the control device is suitable and designed to monitor the load state of the drive system and to recognize at least one load state suitable for switching off the traction motor and to switch off the traction motor depending on whether the suitable load state is present. In particular, the control device comprises sensor means for monitoring the load state of the drive system and/or for detecting the torque and/or the speeds of the traction motors. The applicant reserves the right to claim an at least partially electrically powered motor vehicle and preferably an electric vehicle with the drive system presented here. The drive system can comprise at least one traction battery and/or power electronics.

In particular, the load state of the drive system in which the traction motor is demagnetized is partial load operation. However, demagnetization can also take place in other suitable load states and/or in an energy-saving mode (e.g. to extend the range). The control device can be suitable and designed to demagnetize (all of) the traction motors designed as permanently excited synchronous machines. Demagnetizing all traction motors is useful, for example, if the longest possible coasting time is desired.

The magnetic field generating device is used in particular to generate a controllable magnetic field. In particular, the magnetic field device comprises at least one electric coil device. The coil device is provided in particular by a stator winding. It is also possible that the coil device is designed in addition to or separately from the stator winding. In one embodiment, the (supplementary or separate) coil device can be arranged at least partially in and/or on the rotor. The supplementary or separate coil device can also be arranged at least partially in and/or on the stator. In particular, the permanent magnets can be at least partially demagnetized and magnetized by means of the demagnetizing field. When demagnetization is mentioned in the context of the present disclosure, this is understood in particular to mean at least partial demagnetization.

Further advantages and features of embodiments of the present invention follow from the example embodiments, which are described below with reference to the accompanying drawings.

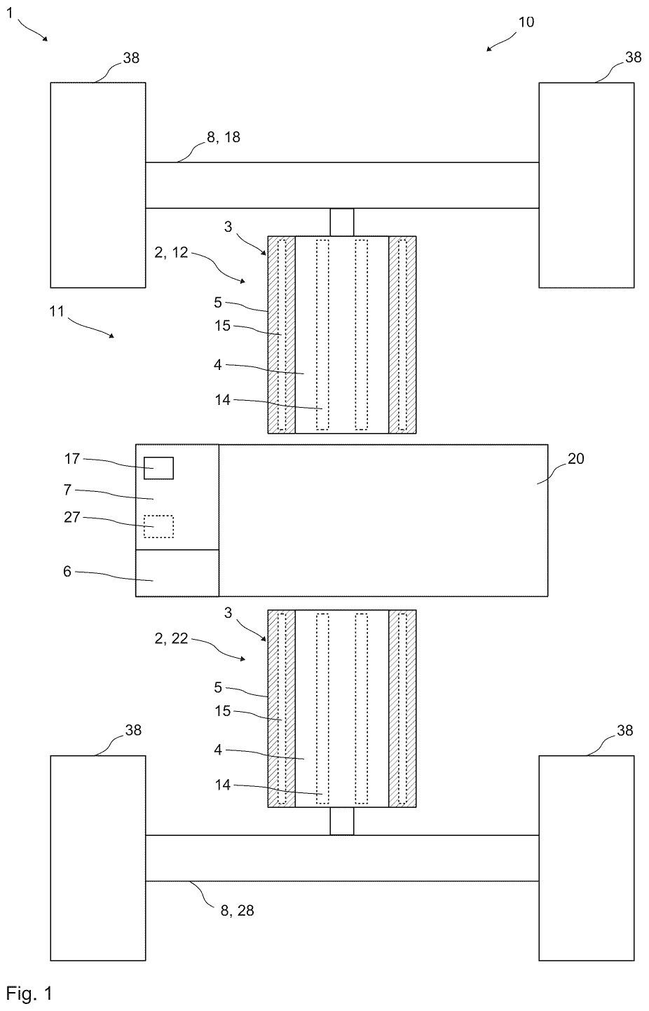

FIG. 1 shows a drive system 1 according to an embodiment of the invention of a motor vehicle 10, shown here only in part, which is designed as an electric vehicle. The drive system 1 can be operated according to the method of an embodiment of the invention and comprises two axle units 8, which are designed as a front axle 18 and a rear axle 28. The drive system 1 comprises a traction drive 11 with two traction motors 2. A first traction motor 12 is used to drive the front axle 18 and a second traction motor 22 is used to drive the rear axle 28. The axle units 8 are each equipped with two wheels 38.

The traction motors 2 are each designed here as a permanently excited electric synchronous machine 3. To this end, the traction motors 2 each comprise a stator 5 and a rotor 4 rotatably mounted in the stator 5. The rotor 4 is equipped with a plurality of permanent magnets 14, shown here as examples. The permanent magnets 14 are used to generate a rotor magnetic field (also known as an excitation field) for the rotor 4. The stator 5 comprises a magnetic field generating device 15 for generating a stator magnetic field (also known as a rotating field).

A traction battery 20, which is designed as a high-voltage battery, for example, is provided to supply the traction drive 11 with energy. Power electronics 7 with an inverter device 17 is provided to control the traction motors 2. The inverter device 17 comprises an inverter 17a for each traction motor 2. For example, the power electronics 7 provides the traction current required for the respective torque requirement.

The drive system 1 is equipped here with a control device 6, which switches off the first traction motor 12 depending on a load state of the drive system 1 and, for example, in partial load operation, so that it runs in a towing mode and is towed along. The second traction motor 22 remains switched on and provides the torque for the rear axle 28. However, it is also possible, for example, for the second traction motor 22 to be switched off while the first traction motor 12 is driving the front axle 18.

The selection of which drive motor 2 is switched off can be fixed or dynamic. The selection can, for example, depend on whether a driven front axle 18 or a driven rear axle 28 is more advantageous for the respective motor vehicle 10.

To reduce or avoid drag losses when towing, the control device 6 can demagnetize the permanent magnets 14 of the switched-off traction motor 2 in a targeted manner. For this purpose, a defined magnetic field, the so-called demagnetization field, is generated with the magnetic field generating device 15. Demagnetization results in a considerable reduction in eddy current losses and hysteresis losses. If the permanent magnets 14 of the rotor 4 are completely demagnetized, for example, only the friction (air and bearing friction) remains as a source of loss.

If a torque request is present and the towing mode is to be ended, the permanent magnets 14 are magnetized again by a defined magnetic field, the so-called magnetization field, to such an extent that the drive delivers its intended torque. For example, the demagnetization field and the magnetization field differ in their magnetic field direction.

A correspondingly high current pulse is used to generate the defined magnetic field. This allows a brief and correspondingly strong magnetic field to be generated in the desired direction in order to achieve the desired magnetization of the permanent magnets 14. The current pulse required here is 3-5 times the nominal current, for example, and is provided by the inverter device 17. Alternatively or additionally, a capacitor device 27 can also be discharged to provide the current pulse.

The permanent magnets 14 are made here from a material with a suitable coercive field strength, so that they can even be essentially completely or at least partially demagnetized by the demagnetizing field. The ratio of the coercive field strength of the permanent magnets 14 and a required amplitude of the current pulse is determined in advance, for example, by numerical calculations and/or the synchronous machine 3 is designed accordingly.

The required current pulse can be implemented here by means of suitable current control during travel (speed not equal to 0; torque not equal to 0) and without a noticeable torque pulse. For example, the torque is constantly adjusted during the demagnetization or magnetization process. If the appropriate torque is required, the permanent magnets 14 can then be completely magnetized again in a short time by the defined magnetic field of the magnetic field generating device 15 and the synchronous machine 3 can be put back into operation.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 Drive system
2 Traction motor
3 Synchronous machine
4 Rotor
5 Stator
6 Control device
7 Power electronics
8 Axle unit
10 Motor vehicle
11 Traction drive
12 first traction motor
14 Permanent magnets
15 magnetic field generating device
17 Inverter device
17a Inverter
18 Front axle
20 Traction battery
22 second traction motor
27 Capacitor device
28 Rear axle
38 Wheel

1. A drive system for an at least partially electrically driven motor vehicle, comprising:
an electric traction drive with at least two electric traction motors, wherein at least one of the traction motors is a permanently excited synchronous machine having a rotor with a plurality of permanent magnets and a stator with a magnetic field generator for generating a stator magnetic field; and
at least one controller configured to switch off the at least one traction motor as a function of a load state of the drive system at least in partial load operation, such that the at least one traction motor is in a towing mode and is towed along while another of the at least two traction motors is still switched on and supplies a torque for driving,
wherein the controller is configured to generate a defined magnetic field with the magnetic field generator and to at least partially demagnetize the permanent magnets of the at least one switched-off traction motor with a demagnetization field of the defined magnetic field such that drag losses are reduced when towing.

2. The drive system according to claim 1, wherein the controller is configured to generate a magnetization field as the defined magnetic field with the magnetic field generator and to magnetize the previously demagnetized permanent magnets of the at least one switched-off traction motor with the magnetization field, such that the at least one traction motor can again supply a driving torque.

3. The drive system according to claim 1, wherein the controller is configured to magnetize the at least one traction motor again at least when a torque requirement is present, for the provision of which the at least one switched-off traction motor is required.

4. The drive system according to claim 2, wherein the control device is configured to generate the defined magnetic field with a defined magnetic field direction and to set a magnetic field direction for the magnetization field which is opposite to the magnetic field direction of the demagnetization field.

5. The drive system according to claim 1, wherein at least one current pulse generates the defined magnetic field.

6. The drive system according to claim 1, wherein a current pulse for generating the defined magnetic field is provided at least partially by power electronics of the traction drive.

7. The drive system according to claim 1, wherein a current pulse for generating the defined magnetic field is provided at least partially by a capacitor.

8. The drive system according to claim 2, wherein the controller is configured to set a current direction of a current pulse for generating the defined magnetic field and to set a current direction for the magnetization field which is opposite to a current direction of the demagnetization field.

9. The drive system according to claim 1, wherein the controller is configured to apply the defined magnetic field to the at least one traction motor under the condition that the at least one traction motor is switched on and supplies a torque for driving and/or that the drive system is in motion.

10. The drive system according to claim 1, wherein the controller is configured to adjust a torque of the at least one connected traction motor during application of the defined magnetic field to the at least one traction motor such that undesired torque pulses are avoided.

11. The drive system according to claim 1, comprising at least two axle units, which are each driven by at least one of the at least two traction motors, wherein the controller is configured to switch off and demagnetize the at least one traction motor to drive at least one of the at least two axle units as a function of the of the drive system such that the towing operation is provided axle by axle.

12. The drive system according to claim 1, comprising a front axle configured to be driven by the at least one traction motor and a rear axle configured to be driven by the at least one traction motor, wherein the controller is configured to switch off and demagnetize the at least one traction motor, which is configured to drive the front axle as a function of the load state of the drive system, such that the front axle is towed along while the rear axle is driven, or wherein the controller is configured to switch off and demagnetize the at least one traction motor configured to drive the rear axle as a function of the load state of the drive system such that the rear axle is towed along while the front axle is driven.

13. The drive system according to claim 1, wherein a magnetic coercive field strength of the permanent magnets of the at least one traction motor designed as a permanently excited synchronous machine and the defined magnetic field generated by the magnetic field generator are matched to one another.

14. A method for operating the drive system according to claim 1.

15. The drive system according to claim 5, wherein the current pulse has a higher current strength and/or amplitude than a nominal current provided for the permanently excited synchronous machine.

16. The drive system according to claim 6, wherein a current pulse for generating the defined magnetic field is provided at least partially by an inverter.
